(19) United States
(12) Patent Application Publication
(10) Pub. No.: US 2011/0290411 A1
(43) Pub. Date: Dec. 1, 2011

(54) Modular System for Fabricating a Reinforced Tubular

(75) Inventors: Nicholas John Venero, Clinton, NY (US); Raymond Nicholas Burke, Cypress, TX (US); Richard James Anthony Smith, Dorset (GB)

(73) Assignee: PIPESTREAM B.V., Houston, TX (US)

(21) Appl. No.: 12/788,724

(22) Filed: May 27, 2010

(51) Int. Cl. B32B 38/00

(52) U.S. Cl. 156/195; 156/459; 156/378

(57) ABSTRACT

A system and method for fabricating reinforced tubular. In some embodiments, the fabrication system includes a plurality of iso-containers positioned at a site where a reinforced tubular is to be installed and equipment disposed within each of the plurality of iso-containers, the equipment operable to produce the reinforced tubular. The equipment includes a caterpullar operable to receive a tubular and push the tubular through the equipment downstream of the caterpullar and a winder operable to wrap the tubular with a reinforcing material to produce the reinforced tubular.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

The disclosure relates generally to pipeline formed by reinforcing a metallic or nonmetallic pipe with martinsitic strip steel helically wound thereabout. More particularly, the disclosure relates a modular system and associated method for fabricating reinforced pipeline at an installation site.

Conventional pipeline construction is a multistep process beginning with the manufacture of linepipe, typically in 40 foot lengths, at a pipe mill. Next, the linepipe may be transported to a coating yard where the linepipe is coated for corrosion resistance. Finally, the coated linepipe is transported to an installation site where it is welded to form a continuous pipeline and laid into a trench that is backfilled. Such construction practices are labor intensive with numerous opportunities for injury and even fatality. Further, costs for transporting the linepipe can be very significant, particularly so when the pipe mill, coating yard, and installation site are great distances apart.

Embodiments of the present invention are directed to a modular reinforced pipeline fabrication system that seeks to overcome these and other limitations of the prior art.

### SUMMARY OF THE DISCLOSURE

A modular reinforced tubular fabrication system and associated methods are disclosed. In some embodiments, the fabrication system includes a caterpullar module having a caterpullar housed within a first iso-container, the caterpullar operable to receive a tubular and push the tubular through one or more modules downstream of the caterpullar module. The fabrication system further includes a winder module having a winder housed within a second iso-container, the winder operable to wrap the tubular received from the caterpullar module with reinforcing material to produce a reinforced tubular. The caterpullar module and the winder module are positioned at a site where the reinforced tubular is to be installed.

In some embodiments, the fabrication system includes a plurality of iso-containers positioned at a site where a reinforced pipeline is to be installed and equipment disposed within each of the plurality of iso-containers, the equipment operable to produce the reinforced pipeline. The equipment includes a caterpullar operable to receive a pipeline and push the pipeline through the equipment downstream of the caterpullar and a winder operable to wrap the pipeline with a reinforcing material to produce the reinforced pipeline.

In some embodiments, the fabrication method includes transporting a plurality of modules to a site where a reinforced tubular is to be installed, each of the modules comprising an iso-container housing equipment operable to fabric the reinforced tubular, positioning the modules at the site in a predetermined configuration, conveying a tubular through the modules using a caterpullar, the caterpullar housed within one of the plurality of modules, and wrapping the tubular with reinforcing material, whereby forming the reinforced tubular, with a winder housing within another of the plurality of modules.

Thus, embodiments described herein comprise a combination of features and characteristics intended to address various shortcomings associated with conventional pipeline construction. The various characteristics described above, as well as other features, will be readily apparent to those skilled in the art upon reading the following detailed description of the preferred embodiments, and by referring to the accompanying drawings.

### BRIEF DESCRIPTION OF THE DRAWINGS

For a detailed description of the disclosed embodiments, reference will now be made to the accompanying drawings in which:

FIGS. 1A and 1B are schematic exterior and cross-sectional representations of a modular reinforced pipeline fabrication system in accordance with the principles disclosed herein;

FIG. 2A is a top view of an exemplary locking device for interlocking with a corner block of a module depicted in FIG. 2B;

FIG. 3 is a front view of an exemplary leveling leg;

FIG. 4 is a perspective view of an exemplary shroud;

FIG. 5 is a perspective view of an exemplary nonmetallic liner pipe with a tensile members applied thereto;

FIGS. 6A and 6B illustrate cross-sections of an exemplary reinforcing material strip with and without, respectively, fusion-bonded epoxy applied thereto;

FIG. 7 is a perspective view of the caterpullar module;

FIG. 8 is a perspective view of the pipeline of FIG. 1B with two strips of reinforcing material wrapped thereabout;

FIGS. 9A and 9B are top and side views of the winder;

FIG. 10 is a perspective view of the tooling head of the winder of FIGS. 9A and 9B; and

FIG. 11 is a perspective view with a copper braid applied to an exemplary reinforced pipeline for cathodic protection.

### DETAILED DESCRIPTION OF THE DISCLOSED EMBODIMENTS

The following description is directed to exemplary embodiments of a modular reinforced pipeline fabrication system and associated methods. The embodiments disclosed should not be interpreted, or otherwise used, as limiting the scope of the disclosure, including the claims. One skilled in the art will understand that the following description has broad application, and that the discussion is meant only to be exemplary of the described embodiment, and not intended to suggest that the scope of the disclosure, including the claims, is limited to that embodiment.

Certain terms are used throughout the following description and the claims to refer to particular features or components. As one skilled in the art will appreciate, different persons may refer to the same feature or component by different names. This document does not intend to distinguish between components or features that differ in name but not function. Moreover, the drawing figures are not necessarily to scale. Certain features and components described herein may be shown exaggerated in scale or in somewhat schematic form, and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections. Further, the terms “axial” and “axially” generally mean along or parallel to a central or longitudinal axis, while the terms “radial” and “radially” generally mean perpendicular to the central or longitudinal axis.

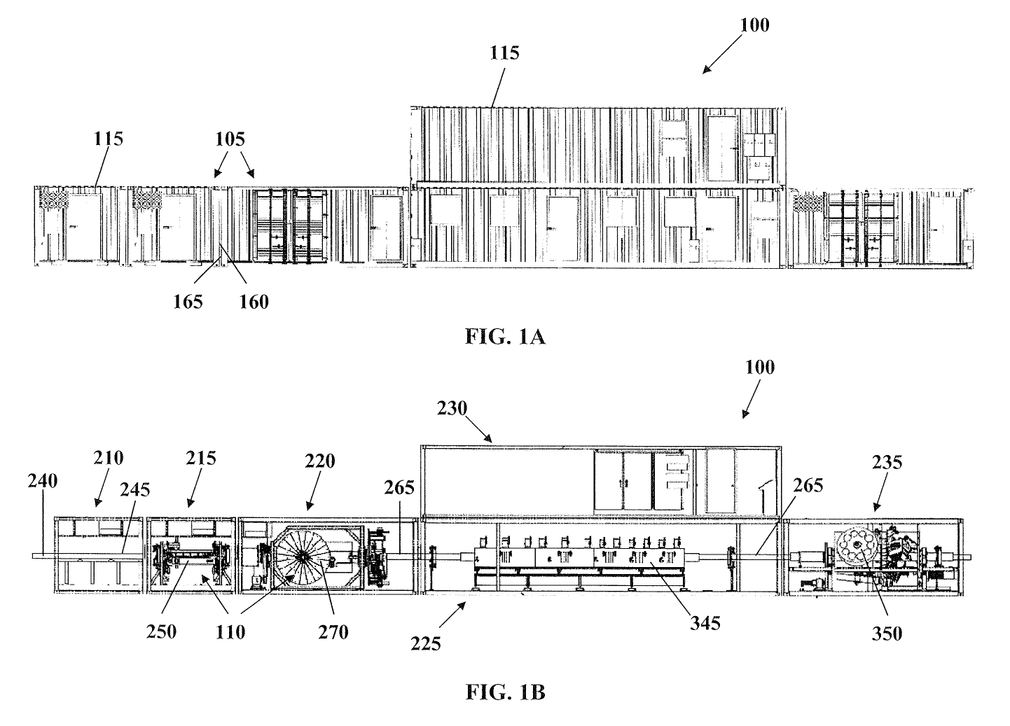

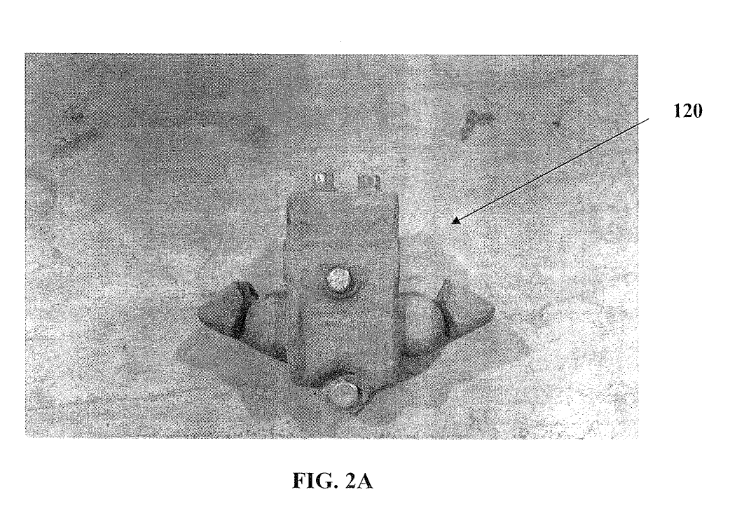

Referring now to FIGS. 1A and 1B, there are shown exterior and cross-sectional views of an embodiment of a modular reinforced tubular fabrication system in accordance with the principles disclosed herein. Fabrication system 100 is operable to produce a reinforced tubular at a site where the reinforced tubular is to be installed. Fabrication system 100 includes a plurality of modules 105, each module 105 having equipment 110 (FIG. 1B) for performing one or more specific functions of the fabrication process housed within an iso-container 115. For this reason, fabrication system 100 may be described as modular. Iso-containers 115 are shipping containers that conform to the standards of the International Organization for Standardization, are available in a variety of standardized sizes, each having one of five standardized lengths, enable efficient transport of items, such as fabrication equipment 110, and are easily manipulated at an installation site, such as by forklift. In some embodiments, iso-containers 115 have air conditioning and/or heating units to enable control of the interior temperature and humidity level of each.

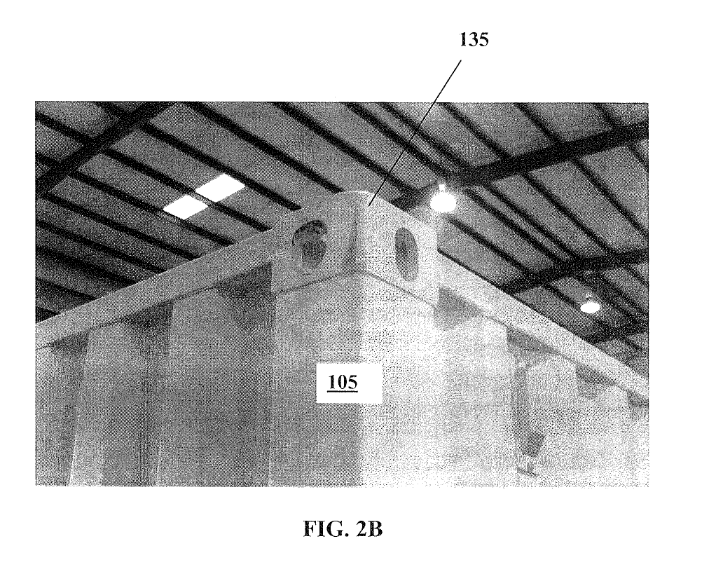

Fabrication system 100 further includes a plurality of locking devices 120, shrouds 125, and leveling legs 130 best viewed in FIGS. 2A, 2B, 3 and 4. Locking devices 120 are coupled between adjacent modules 105 to prevent relative movement of the modules 105 once positioned at an installation site, as illustrated in FIGS. 1A and 1B. FIG. 2A depicts an exemplary locking device 120 that may be used couple adjacent modules 105 via engagement with a corner block 135, best viewed in FIG. 2B, of each of the modules 105.

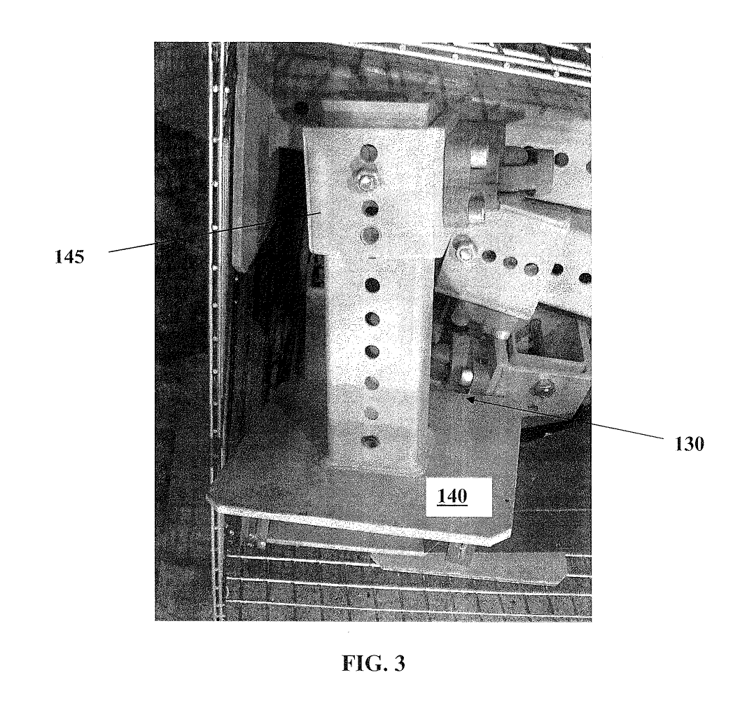

One or more leveling legs 130 are positioned beneath each module 105 and adjusted to ensure modules 105 are level relative to the ground and to each other. FIG. 3 depicts an exemplary leveling leg 130 having a base 140 for engaging the ground and a corner block coupling 145 for interlocking with a module 105. Corner block coupling 145 is movable relative to base 140 to enable leveling of the module 105 relative to the ground and to adjacent modules 105.

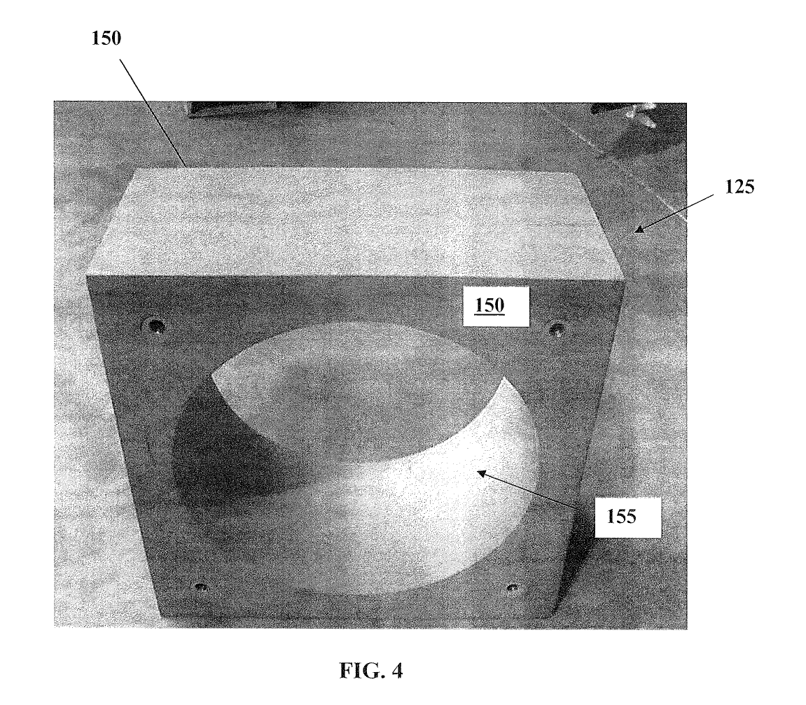

Shrouds 125 are coupled between adjacent modules 105 and/or at each end of fabrication system 100 to protect equipment 110 housed within iso-containers 115 and the reinforced tubular at varying stages of the fabrication process from surrounding environmental conditions. FIG. 4 depicts an exemplary shroud 125. In this embodiment, shroud 125 is rectangular in shape and has two substantially parallel faces 150 with a bore 155 extending therebetween. When shroud 125 is installed between adjacent modules 105, each face 150 is coupled to one of the modules 105 with throughbore 155 positioned such that the reinforced tubular may pass through throughbore 150 from one of the modules 105 to the other of the adjacent modules 105 without being exposed to the surrounding conditions.

The modularity of fabrication system 100 also enables flexibility of the fabrication process. For example, and referring again to FIGS. 1A and 1B, system 100 includes six modules 105, the totality of which enables the fabrication of reinforced tubular at an installation site. Also, modules 105 are arranged substantially in a linear fashion, where an outlet 160 of one module 105 may be proximate an inlet 165 of another module 105. This linear arrangement enables an increase in the fabrication efficiency of system 100. At other installation sites, the fabrication system may require fewer or greater than six modules 105, and those modules 105 may be arranged in a different order than that shown in FIGS. 1A and 1B. Further, the particulars of the installation site may prevent a linear arrangement of modules 105, necessitating another arrangement or layout.

Fabrication system 100 enables wrapping of thin-walled liner pipe with a reinforcing material to produce a reinforced tubular at a site where the reinforced tubular is to be installed. The reinforced tubular may be used in a variety of applications, such as but not limited to a pipeline for conveying fluids, a mast for a yacht, a pillar for a wind turbine, or a pressure vessel. Regardless of the particular application, the liner pipe, reinforcing material, and fabrication system 100 are delivered to a site where system 100 wraps the liner pipe with reinforcing material to produce a reinforced tubular, which is then installed on site.

Preferably the liner pipe comprises a plurality of stainless steel pipe segments. As will be discussed below, the metallic liner pipe is joined by fabrication system 100 to form a continuous length of pipeline. Alternatively, the liner pipe may comprise a nonmetallic material, such as a polymer or plastic. In such embodiments, it may not be necessary to join lengths of the liner pipe at the installation site. Instead, a continuous length of liner pipe may be delivered to the installation site on a spool and dispensed as needed therefrom.

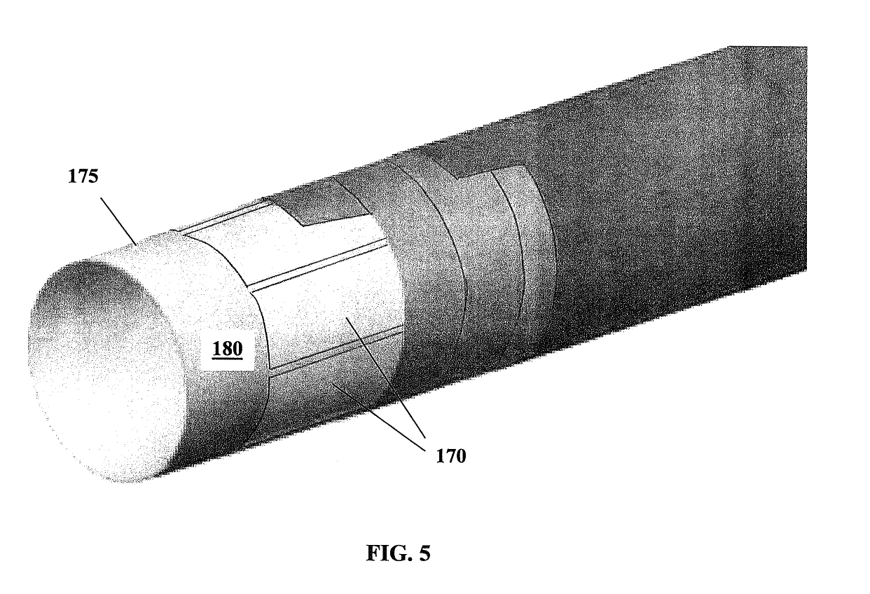

One advantage of nonmetallic liner pipe is that it weighs less than a metallic alternative. However, nonmetallic liner pipe may not be as strong as needed for some applications. In such embodiments, the axial strength of the nonmetallic liner pipe may be enhanced by the application of tensile members. FIG. 5 illustrates a plurality of axially-extending tensile members 170 coupled to an outer surface 175 of an exemplary nonmetallic liner pipe 180. Alternatively, tensile members 170 may be embedded in the material(s) which form nonmetallic liner pipe 180.

The reinforcing material preferably comprises martensitic steel strips pretreated to enable corrosion resistance and sand or grit blasted over all surfaces to enable adhesion to the liner pipe. In some embodiments, each martensitic steel strip is further coated with a fusion-bonded epoxy to resist surface corrosion and abrasion. In such embodiments, the portions of the martensitic steel strips that will form the outer layer of reinforcing material when applied to the liner pipe, and thus will be exposed to ambient conditions, are coated with fusion-bonded epoxy over their outer surface and adjacent edge surfaces while their inner surfaces are not coated. The fusion-bonded epoxy may be that manufactured by 3M Company, Jotun Powder Coatings, E.I. du Pont de Nemours and Company, or any other leading manufacturer of this material. The portions of the martensitic steel strips that will form the inner layers of reinforcing material when applied to the liner piper do not require coating with fusion-bonded epoxy and therefore are not coated.

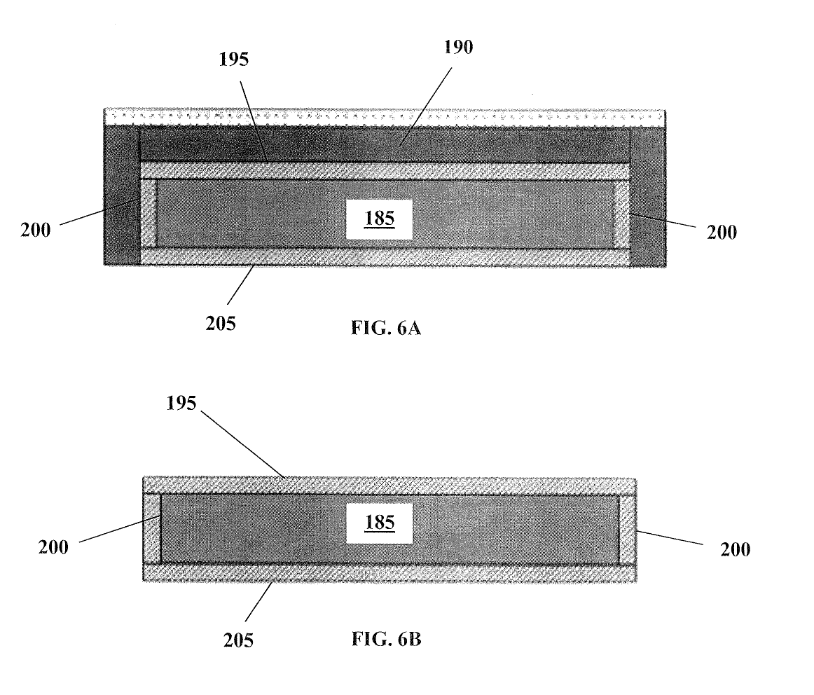

FIGS. 6A and 6B illustrate two cross-sections of an exemplary martensitic steel strip 185. The cross-section of strip 185 depicted in FIG. 6A forms a portion of the outer layer of reinforcing material when applied to the liner pipe. Thus, this portion of strip 185 is coated with fusion-bonded epoxy 190 over its outer surface 195 and it two side surfaces 200, but not over its inner surface 205. The cross-section of strip 185 depicted in FIG. 6B forms a portion of the inner layer of reinforcing material when applied to the liner pipe. Thus, this portion of strip 185 is not coated with fusion-bonded epoxy 190.

As previously described, the liner pipe and reinforcing material are delivered with all modules 105 required for fabrication system 100 to an installation site. In the embodiment illustrated by FIGS. 1A and 1B, fabrication system 100 includes, moving from left to right in FIG. 1B, a preparation module 210, a caterpullar module 215, a winder module 220, a curing module 225, a control room module 230 disposed above curing module 225, and an external coating module 235. Caterpullar module 215 and winder module 220 enable wrapping of a liner pipe with reinforcing material to produce a reinforced tubular. Depending upon material choices and whether the liner pipe is prepared at the site where the reinforced tubular is to be installed, preparation module 210, curing module 225, and/or external coating module 235 may not be necessary for other embodiments of fabrication system 100.

Prior to the wrapping process and assuming the liner pipe to comprise stainless steel pipe segments, the liner pipe is joined to form a continuous length of pipeline. The joining process is performed within preparation module 210. Lengths of liner pipe 240 are fed through inlet 165 of preparation module 210. Within preparation module 210, the lengths of liner pipe 240 are butt-welded end-to-end to form a continuous length of tubular or pipeline 245, which is then output from module 210 through its outlet 160. In some embodiments, liner pipe 240 has a six inch (152 mm) diameter and a length of approximately 20 feet (6 meters). In other embodiments, liner pipe 240 has a length that is approximately twice as long, or 40 feet (12 meters). Further, the lengths of liner pipe 240 are joined through welding to form a continuous pipeline 245 having a length of approximately 1,640 feet (500 meters).

Caterpullar module 215 receives pipeline 245 from preparation module 210. Caterpullar module 215 includes a caterpullar 250 that pulls pipeline 245 from preparation module 210 and essentially pushes pipeline 245 through the remaining modules 105 of fabrication system 100, excluding control room module 150. As such, caterpullar 250 controls the fabrication speed of system 100, absent limitations imposed by preparation module 210 and the supply of liner pipe 240 thereto. In preferred embodiments, including the illustrated embodiment, caterpullar 250 is a caterpullar manufactured by Bartell Machinery Systems, L.L.C., headquartered in Rome, New York.

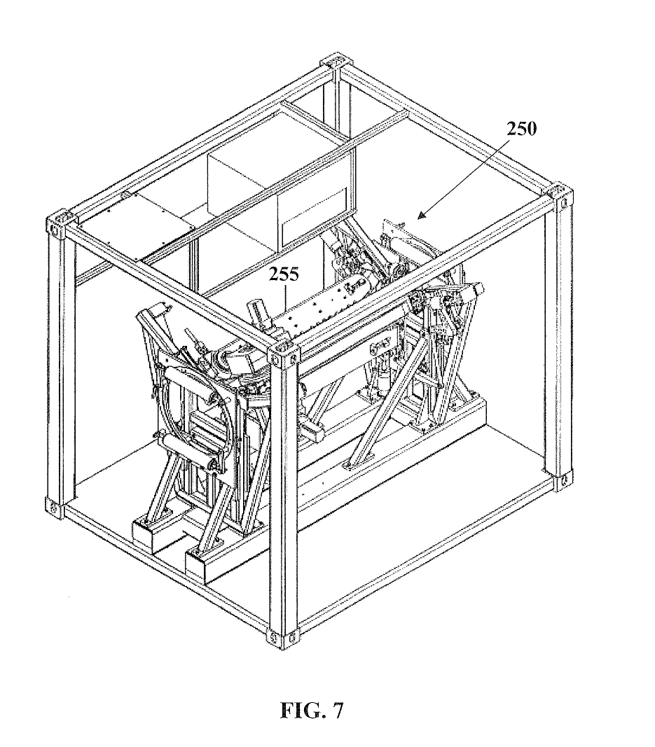

Referring briefly to FIG. 7, caterpullar 250 has three rubber traction belts 255 equally spaced, circumferentially speaking, about the axial centerline of pipeline 245 (FIG. 1B) conveyed therethrough. During fabrication, belts 255 continuously rotate and grip pipeline 245 with sufficient force to pull pipeline 245 from preparation module 210 and drive or push pipeline 245 through modules 105 of fabrication system 100 downstream of caterpullar module 215, namely, winder module 220, curing module 225, and external coating module 235. The positions of belts 255 relative to pipeline 245 are adjustable to center pipeline 245 relative to the downstream modules 220, 225, 235 for a range of pipeline diameters. In the illustrated embodiment, caterpullar 250 accommodates pipeline having a diameter in a range of 6 inches to 10 inches (152 mm to 254 mm).

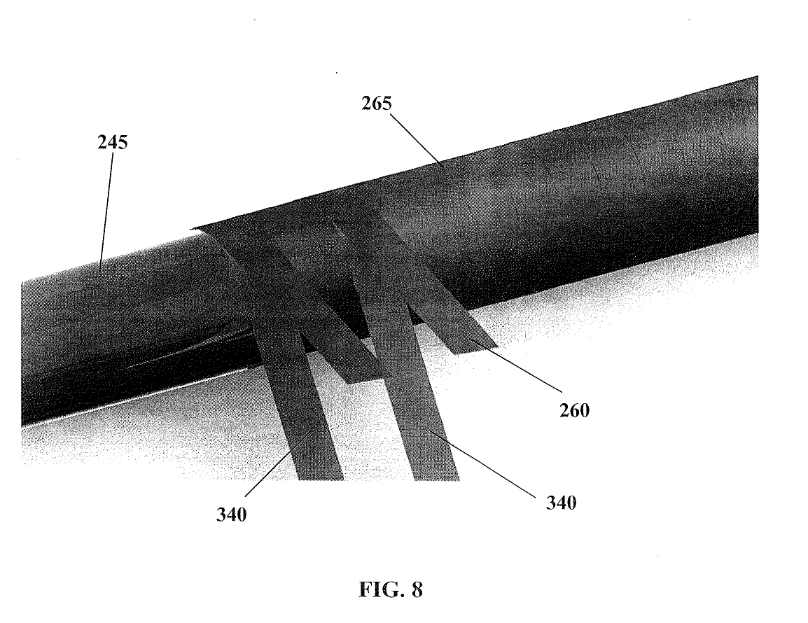

Referring again to FIG. 1B, winder module 220 receives pipeline 245 pushed from caterpullar module 215. Pipeline 245 is wrapped with a reinforcing material 260 to produce reinforced pipeline 265, as illustrated by FIG. 8, within winder module 220. In the illustrated embodiment, reinforcing material 260 is a fusion-bonded epoxy coated martensitic strip steel approximately 0.02 inches (0.5 mm) thick. To perform the wrapping process, winder module 220 includes a winder 270. In preferred embodiments, including the illustrated embodiment, winder 270 is a winder manufactured by Bartell Machinery Systems, L.L.C., headquartered in Rome, New York.

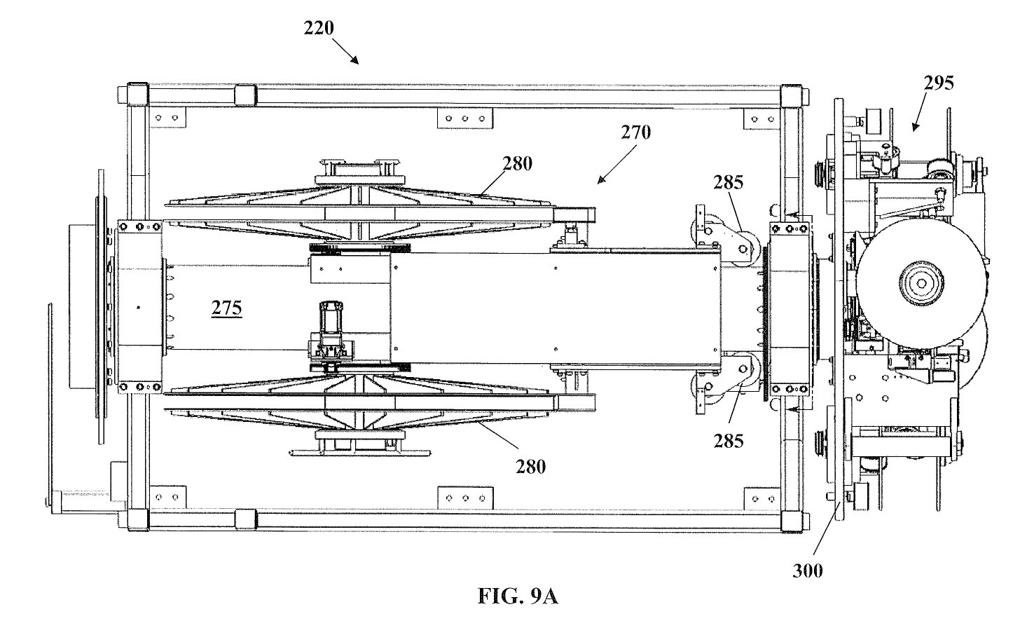

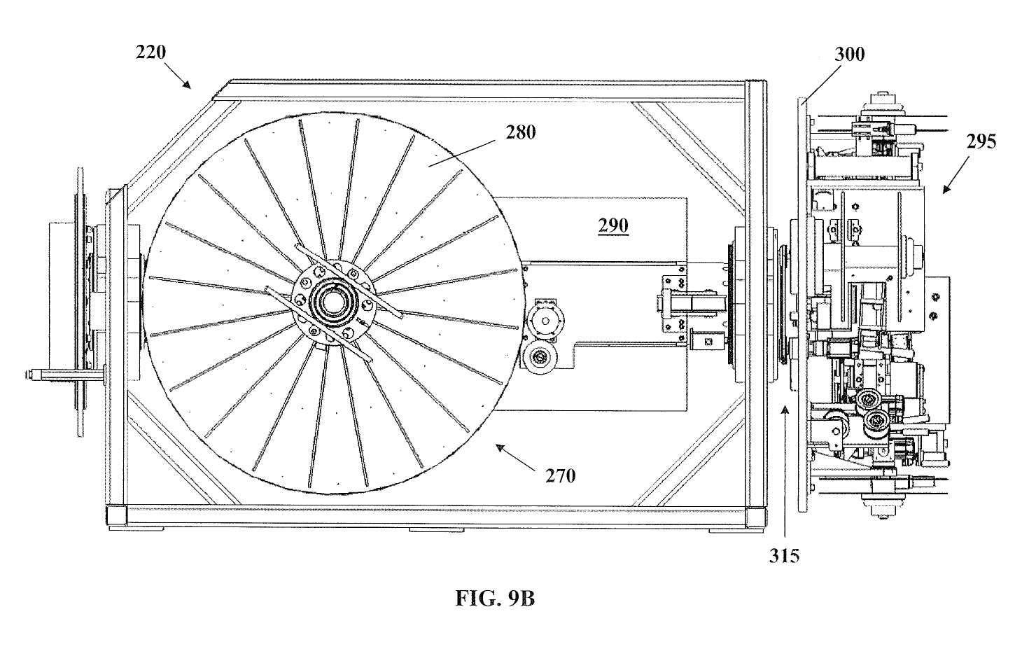

Turning now to FIGS. 9A and 9B, winder 220 includes a main shaft 275, two storage reels 280, guidance rollers 285, an electrical cabinet 290, and a tooling head 295. Pipeline 245 is pushed by caterpullar 250 through main shaft 275 of winder 270. Reinforcing material 260 is stored on reels 280. Reels 280 are rotatable to dispense two strips of reinforcing material 260, each strip passing through a sequence of guidance rollers 285 to tooling head 295 without changing orientation.

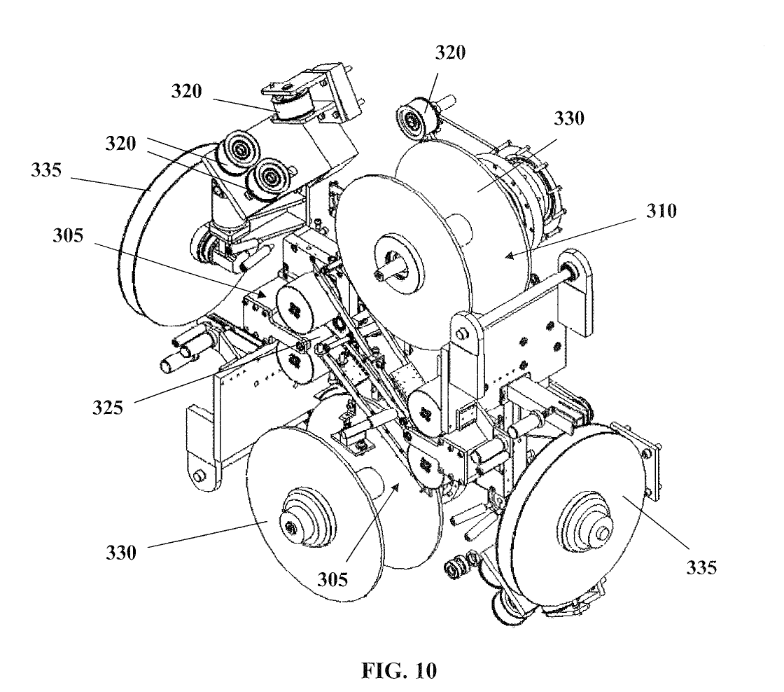

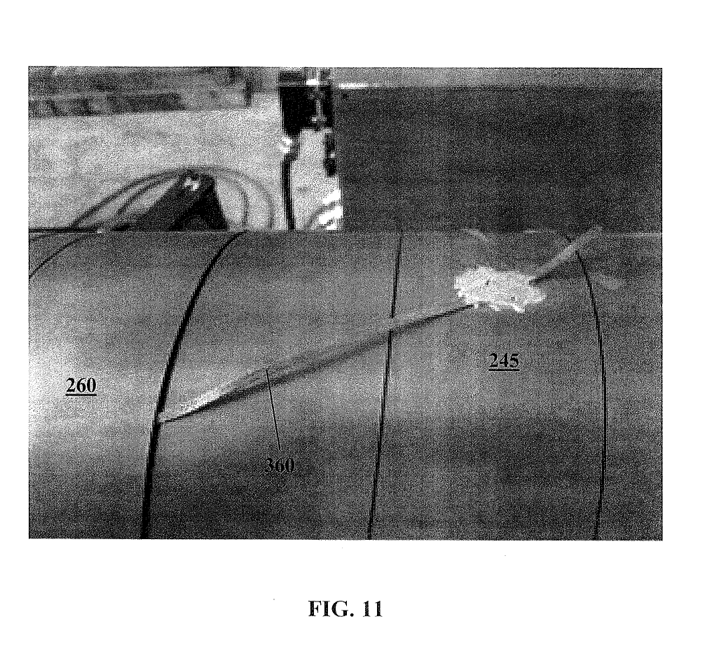

Referring also to FIG. 10, tooling head 295 includes a circular steel plate 300 (FIGS. 9A, 9B) that supports two roll-form assemblies 305 and an adhesive application system 310. Circular plate 300 is rigidly coupled to the downstream end 315 (FIG. 9B) of main shaft 275. Each strip of reinforcing material 260 received from one of storage reels 280 is guided over a series of angled rollers 320 within one roll-form assembly 305 to pipeline 245. As the strip passes over angled rollers 320, it is rigidly constrained and forced over a forming mandrel 325, bending the strip such that it obtains a diameter approximately equal to pipeline 245 and has a helical angle. In some embodiments, pipeline 245 has a six inch diameter and a 6 degree helical angle subsequent to roll-forming.

After roll-forming, an adhesive is applied to the back of each reinforcing material strip to enable coupling of the reinforcing material strips to pipeline 245 passing through winder 270. In some embodiments, including the illustrated embodiment, the adhesive applied is tape. In other embodiments, however, the adhesive may be a paste or another equivalent type of adhesive.

Referring still to FIG. 10, adhesive application system 310 dispenses an adhesive tape to be applied to each reinforcing material strip. Adhesive application system 310 includes two rotatable reels 330 for dispensing adhesive tape with a backing material adhered thereto and two rotatable reels 335 for collecting the backing material removed from the adhesive tape after application to the reinforcing material strips. For each pair of reels 330, 335, adhesive tape 340 (FIG. 3) dispensed by reel 330 is applied to the back of one reinforcing material strip 260, while the backing material is peeled from the adhesive tape and collected by reel 335.

After the adhesive is applied to the reinforcing material strips, the strips are coupled to pipeline 245. Angled rollers 320 are positioned such that each of the strips has a tangential trajectory of pipeline 245 upon reaching its point of application to pipeline 245. Further, in preferred embodiments, the points of application for the strips are axially offset some distance and circumferentially offset 180 degrees, both defined relative to a centerline of pipeline 245. The angular or circumferential offset enables a balancing of forces to pipeline 245 resulting from the application of reinforcing material 260 to pipeline 245 at two distinct locations. With strips roll-formed and properly positioned with adhesive applied to each, the strips are then applied directly to pipeline 245, yielding reinforced pipeline 265.

Reels 280, electrical cabinet 290, and tooling head 295 rotate about main shaft 275, and thus pipeline 245. The strips of reinforcing material 260 are wrapped around pipeline 245 in the same direction of rotation. Due to axial movement of pipeline 245 through winder 270 and rotation of tooling head 295 about pipeline 245, reinforcing material 260 is applied in a helically fashion to pipeline 245, as illustrated by FIG. 8, enabling continuous reinforcement of pipeline 245 throughout its length.

In embodiments wherein pipeline 245 comprises metallic pipe segments joined end-to-end, the wrapping process may be interrupted at regular intervals to enable manual application of copper braiding to pipeline 245 for the purpose of cathodic protection. As is well known in the industry, cathodic protection is used to inhibit corrosion of metallic components, such as but not limited to pipes and pipelines. In such embodiments, illustrated by FIG. 11, a copper braid, or other electrically conductive medium, 360 is soldered to the outer surface of pipeline 245 and woven between layers of reinforcing material 260 such that copper braid 360 extends from pipeline 245 between adjacent layers of reinforcing material 260 to the outer surface of reinforcing material 260 once fully applied to pipeline 245.

Referring again to FIG. 1B, curing module 225 receives reinforced pipeline 265 pushed by caterpullar 250 from winder module 220. Curing module 225 includes infrared cure heaters or ovens 345 operable to emit energy, whereby adhesive applied between adjacent layers of reinforcing material 260 or between reinforcing material 260 and pipeline 245 is cured. In preferred embodiments, curing ovens 345 are curing ovens manufactured by Heraeus Noblelight GmbH located at Reinhard Heraeus Ring 7, D-63801 in Kleinostheim, Germany. Depending on the type of adhesive applied, curing may, however, not be necessary. In such cases, fabrication system 100 does not require curing module 225.

Finally, external coating module 235 receives reinforced pipeline 265 pushed by caterpullar 250 from curing module 220. External coating module 235 includes a coating applicator 350 which applies an external coating to reinforced pipeline 265 passing therethrough. The applied protective coating acts as a barrier between reinforced pipeline 265 and the surrounding environment, reducing the potential for corrosion of reinforced pipeline 265. In some embodiments, external coating module 235 further includes a heater operable to heat the external coating prior to application to reinforced pipeline 265. In the illustrated embodiment, coating applicator 235 is operable to wrap reinforced pipeline 265 with one or more layers of a protective coating, such as but not limited to plastic or polyurethane. Alternatively, the external coating may comprise a spray, and coating applicator 235 may be another type of apparatus operable to apply a spray, rather than a wrap.

Furthermore, in some embodiments, an optical fiber may be applied to outer surface of reinforced pipeline 265 prior to application of the external coating. Once the external coating is applied to reinforced pipeline 265, the optical fiber is embedded between reinforced pipeline 265 and the external coating. The optical fiber enables monitoring of some conditions of reinforced pipeline 265, e.g. strain and/or temperature, for the purpose of leak detection.

Control room module 230 enables remote monitoring and control of the fabrication process, in particular the processes performed within each of modules 105 without the need for personnel to be positioned therein. This functionality is enabled by equipment contained within electronic cabinet 290 of winder module 220 and similar cabinets within other of modules 105. In some embodiments, control room module 230 also enables video monitoring of the processed performed within one or more modules 105.

While various embodiments have been shown and described, modifications thereof can be made by one skilled in the art without departing from the spirit and teachings herein. The embodiments herein are exemplary only, and are not limiting. Many variations and modifications of the apparatus disclosed herein are possible and within the scope of the invention. For example, although the embodiments of a cavity pressure relief system described above are presented in the context of a bi-directional valve, the cavity pressure relief system is equally applicable to uni-directional valves as well. Moreover, the valve described herein is a ball valve. A cavity pressure relief system in accordance with the principles disclosed herein may also be applied to other types of valves which are actuatable between open and closed configurations. Accordingly, the scope of protection is not limited by the description set out above, but is only limited by the claims which follow, that scope including all equivalents of the subject matter of the claims.

1. A fabrication system comprising:
a caterpullar module including a caterpullar housed within a first iso-container, the caterpullar operable to receive a tubular and push the tubular through one or more modules downstream of the caterpullar module;
a winder module including a winder housed within a second iso-container, the winder operable to wrap the tubular received from the caterpullar module with reinforcing material to produce a reinforced tubular; and
wherein the caterpullar module and the winder module are positioned at a site where the reinforced tubular is to be installed.

2. The fabrication system of claim 1, further comprising a preparation module wherein lengths of liner pipe are joined by welding to form the tubular.

3. The fabrication system of claim 1, wherein the winder comprises:
a roll-forming assembly wherein the reinforcing material is preformed; and
an adhesive application system operable to apply an adhesive to the reinforcing material after roll-forming.

4. The fabrication system of claim 3, further comprising a curing module having an infrared oven operable to cure the adhesive.

5. The fabrication system of claim 1, further comprising a control room module wherein operation of the caterpullar and of the winder is remotely monitored and controlled.

6. The fabrication system of claim 1, further comprising an external coating module wherein an external coating is applied to the reinforced tubular, the external coating forming a barrier between the reinforced tubular and surrounding conditions.

7. The fabrication system of claim 6, further comprising an optical fiber disposed beneath the external coating, the optical fiber configured to provide data indicative of conditions of the reinforced tubular.

8. The fabrication system of claim 1, wherein the tubular comprises a metallic material and is coated with fusion-bonded epoxy.

9. The fabrication system of claim 1, further comprising copper braiding coupled to an outer surface of the tubular and extending between adjacent layers of the reinforcing material, the copper braiding configured to provide cathodic protection to the reinforced tubular.

10. The fabrication system of claim 1, wherein the tubular comprises nonmetallic material.

11. The fabrication system of claim 10, wherein the tubular further comprises a plurality of axially extending tensile members, the tensile members configured to increase the axial strength of the tubular.

12. A fabrication system comprising:
a plurality of iso-containers positioned at a site where a reinforced pipeline is to be installed; and
equipment disposed within each of the plurality of iso-containers, the equipment operable to produced the reinforced pipeline and comprising:
a caterpullar operable to receive a pipeline and push the pipeline through the equipment downstream of the caterpullar; and
a winder operable to wrap the pipeline with a reinforcing material to produce the reinforced pipeline.

13. The fabrication system of claim 12, wherein the iso-containers are coupled end to end via a plurality of locking devices.

14. The fabrication system of claim 12, further comprising one or more shrouds coupled between adjacent iso-containers, the shrouds operable to protect the pipeline and the reinforced pipeline from ambient conditions.

15. The fabrication system of claim 12, further comprising one or more leveling legs.

16. The fabrication system of claim 12, wherein the winder comprises:
two reels storing the reinforcing material, each reel rotatable to dispense a strip of the reinforcing material; and
two forming mandrels, each forming mandrel receiving one strip of the reinforcing material and bending the strip to a preselected diameter and a preselected helical angle.

17. The fabrication system of claim 16, further comprising:
two reels storing adhesive tape, each reel rotatable to dispense the adhesive tape for application to one of the strips of reinforcing material; and
two reels receiving backing material removed from the adhesive tape.

18. The fabrication system of claim 12, wherein at least one of the plurality of modules comprises one of an air conditioning unit and a heater.

19. A fabrication method comprising:
transporting a plurality of modules to a site where a reinforced tubular is to be installed, each of the modules comprising an iso-container housing equipment operable to fabricate the reinforced tubular;
positioning the modules at the site in a predetermined configuration;
conveying a tubular through the modules using a caterpullar, the caterpullar housed within one of the plurality of modules; and
wrapping the tubular with reinforcing material, whereby forming the reinforced tubular, with a winder housed within another of the plurality of modules.

20. The method of claim 19, further comprising coupling at least some of the modules end to end at the site.

21. The fabrication method of claim 20, wherein the first strip and the second strip of reinforcing material are applied at distinct locations on the pipeline, the distinct locations circumferentially spaced by approximately 180 degrees.

22. The method of claim 19, further comprising:
joining a plurality of liner pipe sections end to end via welding, whereby the tubular is formed, in one of the plurality of modules positioned upstream of the caterpullar; and
feeding the tubular to the caterpullar.

23. The method of claim 19, wherein the wrapping the tubular comprises:
dispensing a first strip of reinforcing material from a storage reel;
conveying the first strip of reinforcing material through a forming mandrel, whereby the first strip is bent to a preselected diameter and a preselected helical angle; and
applying the first strip of reinforcing material to the tubular, whereby forming the reinforced tubular.

24. The method of claim 19, wherein the wrapping the tubular comprises:
dispensing a second strip of reinforcing material from another storage reel;
conveying the second strip of reinforcing material through another forming mandrel, whereby the second strip is bent to the preselected diameter and the preselected helical angle; and
applying the second strip of reinforcing material to the tubular.

25. The fabrication method of claim 19, further comprising:
applying adhesive tape with the winder to the first strip of reinforcing material; and
curing the adhesive tape using an infrared oven positioned in one of the plurality of modules.

26. The fabrication method of claim 19, further comprising:
applying an external coating to the reinforced pipeline using a coating applicator housing in one of the plurality of modules.
